(19) United States
(12) Patent Application Publication
(10) Pub. No.: US 2023/0388469 A1
(43) Pub. Date: Nov. 30, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yoshihiko MINATO, Kanagawa (JP)

(21) Appl. No.: 18/320,281

(22) Filed: May 19, 2023

(30) Foreign Application Priority Data
May 26, 2022 (JP) 2022-085916

(51) Int. Cl. H04N 13/117; H04N 21/472

(52) U.S. Cl. CPC H04N 13/117; H04N 21/47217

(57) ABSTRACT

A virtual viewpoint operating unit obtains time codes, positions and orientation information on virtual viewpoints, and the like to be designated as key frame information based on a user operation, and registers the information with a key frame setting unit. A virtual viewpoint variation measuring unit detects a precipitous section in a virtual viewpoint path based on the key frame information stored in a key frame storing unit. In a case where the precipitous section is detected in the virtual viewpoint path, an image generating method determining unit determines a method of generating a virtual viewpoint image between the key frames based on variations of virtual viewpoint parameters measured by the virtual viewpoint variation measuring unit and the registered virtual viewpoint parameters of the key frames. A playback speed adjusting unit changes the key frame information and stores the changed key frame information again.

### BACKGROUND

### Field

The technique of the present disclosure relates to a processing technique for editing a virtual viewpoint path for generating a virtual viewpoint image.

### Description of the Related Art

A technique for generating a virtual viewpoint image representing a view from an imaging apparatus (a virtual viewpoint), which is virtually located in a three-dimensional space but is not actually present, by using multiple view images obtained by synchronously image capturing of an identical subject (an object) with multiple imaging apparatuses installed at different locations has been drawing attention. According to the aforementioned technique for generating the virtual viewpoint image from the multiple view images, it is possible to view highlights of a football or basketball game from various angles, for example. Hence, this technique can provide a viewer with more realism than ordinary captured images.

Meanwhile, a distribution model designed to send a server a virtual viewpoint path created by a user by means of operating a virtual viewpoint, and to distribute a virtual viewpoint image rendered based on the virtual viewpoint path created on the server by the user from the server to the user has been in review. A desired virtual viewpoint image cannot be generated in a case where the virtual viewpoint path to be created is set to outside of a settable range of the virtual viewpoint. In this regard, Japanese Patent Laid-Open No. 2017-212592 discloses a method of enabling a user who creates a virtual viewpoint path to set the virtual viewpoint path within a settable range of a virtual viewpoint.

However, the technique according to Japanese Patent Laid-Open No. 2017-212592 is configured to generate a virtual viewpoint image in conformity to the virtual viewpoint path created by the user as long as the virtual viewpoint path falls within the settable range. As a consequence, a virtual viewpoint image to cause an observer to feel an image sickness may be generated in a case where the user carries out an operation to move the virtual viewpoint rapidly so as to create a precipitous section in the virtual viewpoint path.

Given the circumstances, it is an object of the present disclosure to create a virtual viewpoint path for generating a virtual viewpoint image that is less likely to bring about an image sickness of an observer.

### SUMMARY

The present disclosure provides an information processing apparatus that creates a virtual viewpoint path indicating a trajectory of positions of a virtual viewpoint in a virtual viewpoint image generated based on captured images obtained by image capturing from different directions by using imaging apparatuses. The apparatus includes: an accepting unit that accepts parameters indicating virtual viewpoints corresponding to key frames provided as references for the virtual viewpoint path, and a creating unit that creates the virtual viewpoint path by interpolating parameters indicating virtual viewpoints corresponding to an intermediate frame based on the parameters indicating the virtual viewpoints corresponding to the key frames accepted by the accepting unit. In a case where a difference between the parameters indicated by two virtual viewpoints, which correspond to continuous two key frames out of the parameters indicating the virtual viewpoints corresponding to the key frames accepted by the accepting unit, is larger than a threshold, the creating unit creates the virtual viewpoint path such that the number of the virtual viewpoints corresponding to the intermediate frame to be interpolated between the parameters indicating the virtual viewpoints corresponding to the two key frames is larger than the number of the virtual viewpoints in a case where the difference between the parameters indicated by the two virtual viewpoints is equal to or below the threshold.

Further features of the present disclosure will become apparent from the following description of exemplary embodiments with reference to the attached drawings.

### BRIEF DESCRIPTION OF THE DRAWINGS

FIG. 1 is a diagram showing an example of a hardware configuration of an information processing apparatus;

FIG. 2 is an overall functional configuration diagram of a first embodiment;

FIG. 3 is a schematic diagram for explaining a UI for editing a virtual viewpoint path;

FIG. 4 is a diagram showing an example of virtual viewpoint parameters associated with key frames that constitute a precipitous virtual viewpoint path in the first embodiment;

FIG. 5 is a flowchart of processing to create a virtual viewpoint path in the first embodiment;

FIG. 6 is a flowchart of processing to detect a precipitous section on the virtual viewpoint path in the first embodiment;

FIG. 7A is a diagram showing a setting example of virtual viewpoint parameters in a case where a virtual viewpoint is moved by changing a playback speed of a three-dimensional model in the first embodiment;

FIG. 7B is a diagram showing a setting example of virtual viewpoint parameters in a case where a virtual viewpoint is moved by performing switching according to the first embodiment;

FIG. 7C is a diagram showing a setting example of virtual viewpoint parameters in a case where a virtual viewpoint is moved by stopping time of a three-dimensional model according to the first embodiment;

FIG. 8 is an overall functional configuration diagram of a second embodiment;

FIG. 9 is a flowchart of processing to generate a virtual viewpoint path in the second embodiment;

FIG. 10A is a diagram showing a designation example of an image clip in the second embodiment;

FIG. 10B is a diagram showing an example of setting a slow mode in the second embodiment;

FIG. 10C is a diagram showing an example of setting a switching mode in the second embodiment; and

FIG. 10D is a diagram showing an example of setting a stop mode in the second embodiment.

### DESCRIPTION OF THE EMBODIMENTS

### First Embodiment

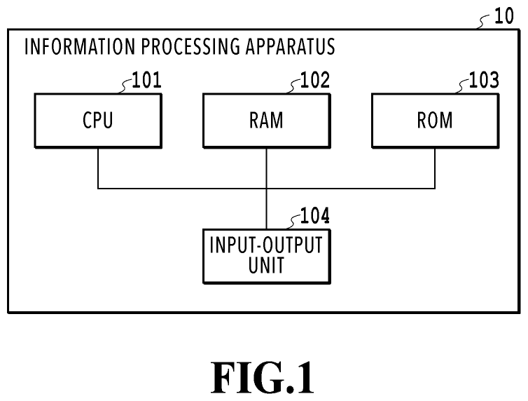

FIG. 1 is a diagram for explaining a hardware configuration of an information processing apparatus according to a first embodiment of the present disclosure.

A CPU 101 controls the entire information processing apparatus by using computer programs and data which are stored in a RAM 102 and a ROM 103. Here, the information processing apparatus may include one or more dedicated hardware devices or graphic processing units (GPU) which are different from the CPU 101, and at least part of processing to be handled by the CPU 101 may be carried out by the GPU or the dedicated hardware devices instead. Examples of the dedicated hardware devices include an application specific integrated circuit (ASIC), a digital signal processor (DSP), and so forth.

The RAM 102 temporarily stores the computer programs and the data read out of the ROM 103, data to be supplied from outside through an input-output unit 104, and the like.

The ROM 103 retains the computer programs and the data which do not require changes.

The input-output unit 104 inputs and outputs data to and from a controller for editing a virtual viewpoint path, a display unit for displaying a GUI, and the like.

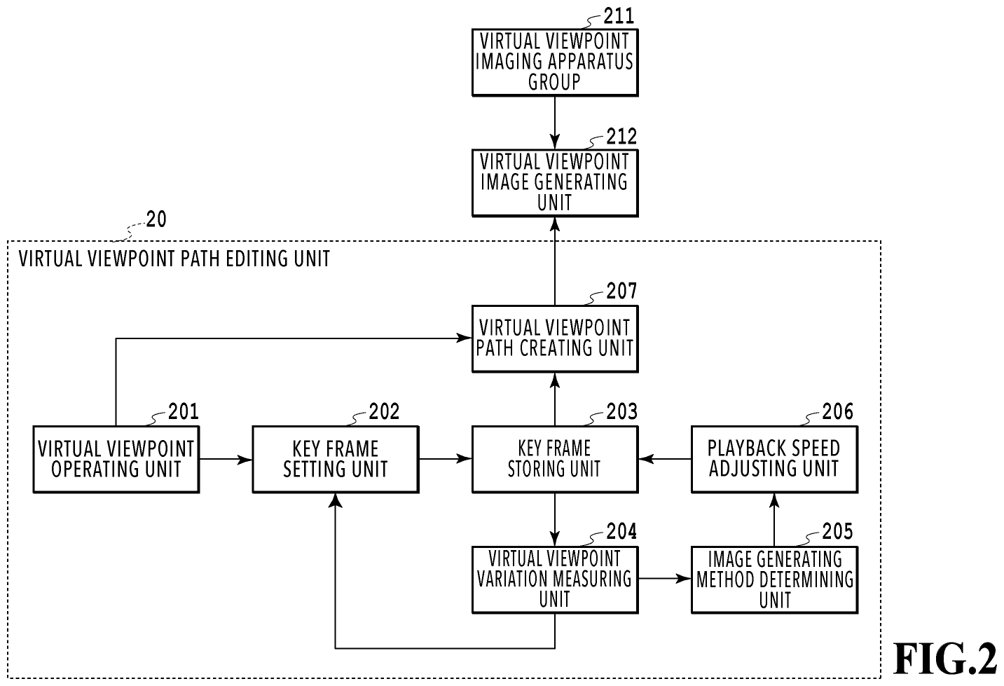

FIG. 2 is a diagram showing an example of a functional configuration concerning creation of a virtual viewpoint path of an information processing apparatus 10 shown in FIG. 1.

A virtual viewpoint path editing unit 20 is formed from a virtual viewpoint operating unit 201, a key frame setting unit 202, a key frame storing unit 203, a virtual viewpoint variation measuring unit 204, an image generating method determining unit 205, a playback speed adjusting unit 206, and a virtual viewpoint path creating unit 207.

The virtual viewpoint path editing unit 20 determines a parameter group of a series of virtual viewpoint parameters (hereinafter referred to as virtual viewpoint parameters) that control a virtual viewpoint and constitute a virtual viewpoint path. The virtual viewpoint parameters include parameters that designate at least any one of a position, an orientation, a zoom, and a clock time. A position of the virtual viewpoint to be designated by the virtual viewpoint parameters may represent three-dimensional coordinates, which may be expressed by the Cartesian coordinate system that has three axes of x axis, y axis, and z axis, for example. In the present embodiment, the position to be designated by the virtual viewpoint parameters is formed from respective parameters of x coordinate, y coordinate, and z coordinate of the Cartesian coordinate system. Here, a point of origin of the coordinate system may be set to an arbitrary position in a three-dimensional space. The orientation of the virtual viewpoint designated by the virtual viewpoint parameters may be expressed by angles formed by three axis of pan axis, tilt axis, and roll axis. The orientation of the virtual viewpoint designated by the virtual viewpoint parameters may be formed from parameters of the three axes of the pan axis, the tilt axis, and the roll axis. A zoom of the virtual viewpoint to be designated by the virtual viewpoint parameters is defined by one axis of a focal distance, for example, and a clock time expressed by a time code is also a parameter on one axis. Accordingly, the virtual viewpoint parameters of the virtual viewpoint includes at least parameters of eight axes, namely, the x coordinate, y coordinate, z coordinate, pan, the tilt, zoom, and time code axes. The virtual viewpoint path editing unit 20 can control these eight axes.

Here, the virtual viewpoint parameters may include a parameter that defines another element. Alternatively, the virtual viewpoint parameters do not have to include all of the parameters of the eight axes mentioned above. The virtual viewpoint path editing unit 20 transmits the series of the virtual viewpoint parameter group thus determined to a virtual viewpoint image generating unit 212. Next, the virtual viewpoint image generating unit 212 generates a virtual viewpoint image based on the virtual viewpoint parameters of the virtual viewpoint path thus received.

A virtual viewpoint imaging apparatus group 211 carries out synchronous image capturing by using multiple imaging apparatuses installed in such a way as to surround a playing field and the like, and outputs captured images obtained by the image capturing to the virtual viewpoint image generating unit 212.

The virtual viewpoint operating unit 201 carries out virtual viewpoint control based on user input, and outputs a result of control as the virtual viewpoint parameters to the virtual viewpoint path creating unit 207 and the key frame setting unit 202. Here, the virtual viewpoint parameters include at least parameters indicating the position and the orientation of each virtual viewpoint. However, without limitations to the foregoing, the virtual viewpoint parameters may include a parameter that indicates an angle of view of the virtual viewpoint, for example.

The key frame setting unit 202 sets key frame information based on the virtual viewpoint parameters inputted from the virtual viewpoint operating unit 201 and on key frame setting information, and outputs the key frame information to the key frame storing unit 203. Here, the key frame setting information is the information that indicates whether or not to set a frame associated with the virtual viewpoint parameters obtained by the virtual viewpoint operating unit 201 as a key frame and whether or not to store the key frame. A user may explicitly determine whether or not to set each frame as the key frame by using the virtual viewpoint operating unit 201, or every frame associated with the virtual viewpoint parameters inputted as a consequence of the operation of the virtual viewpoint operating unit 201 by the user may be determined as the key frame. The key frame information is the information in which the time code of the key frame, a playback speed of a three-dimensional model between adjacent key frames, and the virtual viewpoint parameters are correlated with one another.

The key frame storing unit 203 stores the key frame information set by the key frame setting unit 202. The stored key frame information is outputted to the virtual viewpoint variation measuring unit 204 and the virtual viewpoint path creating unit 207.

The virtual viewpoint variation measuring unit 204 calculates variations of the virtual viewpoint parameters per unit time in the captured images between the key frames stored in the key frame storing unit 203 and outputs the calculated variations to the image generating method determining unit 205.

The image generating method determining unit 205 determines an image generation method based on the variations of the virtual viewpoint parameters per unit time in the captured images between the key frames calculated by the virtual viewpoint variation measuring unit 204, and outputs information concerning the image generation method to the playback speed adjusting unit 206.

The image generation method represents any of “slow”, “switching”, and “stop” modes and the like to be determined depending on the variations per unit time in the captured images between the virtual viewpoints corresponding to the key frames as well as position coordinates of the virtual viewpoints at that time, or depending on user settings and the like. Specific descriptions of these modes will be described later.

The playback speed adjusting unit 206 outputs playback speed information to the key frame storing unit 203, which represents a playback speed between the key frames in a case where the virtual viewpoint image is generated based on the image generation method determined by the image generating method determining unit 205. Here, the playback speed information is a playback speed that is relative to a playback speed of the virtual viewpoint image, which represents a percentage on the assumption that normal playback at a normal speed is defined as 100%.

The virtual viewpoint path creating unit 207 creates the virtual viewpoint path by interpolating between the virtual viewpoint parameters outputted from the virtual viewpoint operating unit 201, or between the virtual viewpoint parameters of at least two key frames stored in the key frame storing unit 203. Here, the virtual viewpoint path is expressed by time-continuous virtual viewpoint parameters. The virtual viewpoint path creating unit 207 conducts association with time codes in the case of creating the virtual viewpoint path so as to be able to specify the virtual viewpoint parameters corresponding to the respective frames.

The virtual viewpoint image generating unit 212 generates a three-dimensional model from a multiple view image obtained by the synchronous image capturing with the virtual viewpoint imaging apparatus group 211. Then, the virtual viewpoint image is generated by mapping textures based on the virtual viewpoints (the positions, the orientations, and the angles of view of the virtual viewpoints) in the virtual viewpoint path created by the virtual viewpoint path creating unit 207.

Note that the information processing apparatus of the present disclosure can also be used for editing a virtual viewpoint path of a CG image. In this instance, a CG renderer is provided instead of the virtual viewpoint image generating unit 212. The virtual viewpoint in this case represents a viewpoint located in a CG space for generating the CG image, which is assumed to be movable to an arbitrary location in the CG space.

### (Regarding Virtual Viewpoint Path)

The virtual viewpoint path is configured to define a motion of the virtual viewpoint in a video image generated by sequentially playing back multiple virtual viewpoint images or multiple CG images. This virtual viewpoint path is managed based on frames and time lines. A frame holds information necessary for generating the respective images constituting the video image. Specifically, the frame holds information on clock times (time codes) of scenes as well as the positions and the orientations of the virtual viewpoints. Each clock time of the scene is expressed by a time code while defining the clock time of start of a game targeted for image capturing as a frame at 00 hour, 00 minute, 00 second and 00, for example. The position of each virtual viewpoint is expressed by three coordinates of the x coordinate, the y coordinate, and the z coordinate while setting the point of origin in an image capturing space, for example. The orientation of each virtual viewpoint is expressed by three angles of a pan angle, a tilt angle, and a roll angle, for example. The number of frames included in the time line is determined based on the number of images to be played back in each second (a frame rate). In the case where the frame rate is 60 frames/sec., for example, the frames in the number corresponding to 60×(the length of the time line (in seconds)) are included in the time line.

In editing the virtual viewpoint path by using the virtual viewpoint parameters associated with the key frames, the frames are categorized into two types of key frames and intermediate frames. A key frame is a frame including information explicitly designated by a user who edits the virtual viewpoint path. On the other hand, an intermediate frame is a frame between the key frames. The virtual viewpoint parameters of the intermediate frame are determined by interpolation based on the virtual viewpoint parameters of the key frames to be carried out by the virtual viewpoint path editing unit 20.

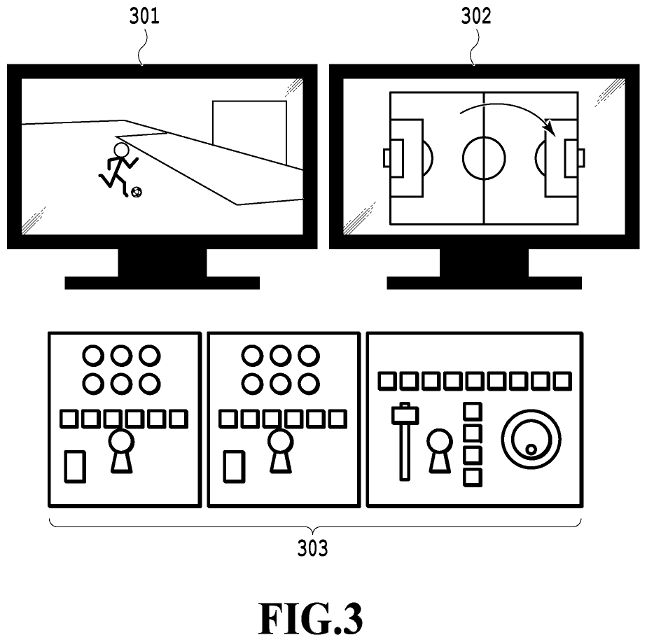

FIG. 3 shows an example of a user interface (UI) for editing a virtual viewpoint path. A virtual viewpoint image display unit 301 displays the virtual viewpoint image generated by the virtual viewpoint image generating unit 212, namely, the virtual viewpoint image that is viewed from the virtual viewpoint. A GUI display unit 302 displays the virtual viewpoint path, the key frame information, and the like. A virtual viewpoint path editing controller 303 is a controller used by the user in order to edit the virtual viewpoint path.

Here, the virtual viewpoint path editing unit 20 transmits the information on the frames targeted for editing by the user constantly to the virtual viewpoint image generating unit 212. The virtual viewpoint image generating unit 212 generates the virtual viewpoint images based on the received information on the frames. The generated virtual viewpoint images are transmitted to and displayed on the virtual viewpoint image display unit 301. This enables the user to edit the virtual viewpoint path while constantly checking the virtual viewpoint images corresponding to the frames targeted for editing.

### (Explanations Concerning Problem)

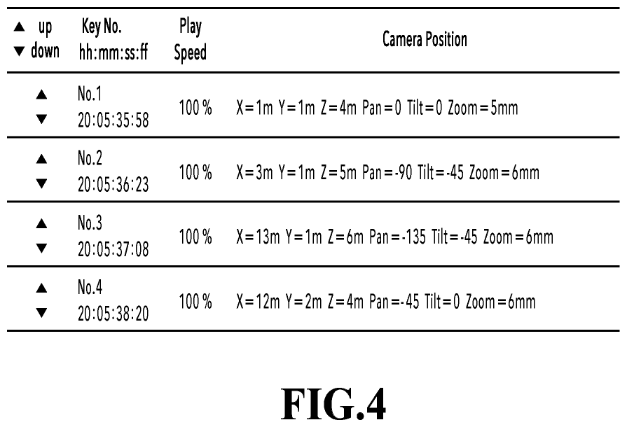

Now, a problem to be solved by the present disclosure will be described by using the user interface for setting the key frame information shown in FIG. 4. The present embodiment is premised on production of image clips in accordance with a key frame method. From the left end to the right in FIG. 4, settings of the key frame information indicate switches for sorting the key frames, the number indicating the order of the key frames and the time codes thereof, playback speeds during intervals to subsequent key frames, and the positions and orientation information on the virtual viewpoints. The user who produces the image clips determines the position and the orientation of the virtual viewpoint as well as the playback speed regarding an arbitrary time code and registers these pieces of information as the key frame information. At least two pieces of the key frame information are registered by repeating this operation. In this instance, the variation of the virtual viewpoint per unit time in the captured image grows larger in a case where a time code interval between the registered key frames is short and a change in position or orientation of the virtual viewpoint is large. In the above-described case, there is a possible to bring about an adverse effect such as an image sickness to a viewer of the virtual viewpoint image.

To be more precise, the virtual viewpoint moves 10 m in x-axis direction in 45 frames between second and third key frames in FIG. 4. In other words, the virtual viewpoint moves 10 m in a very short period less than one second. Accordingly, the virtual viewpoint images generated based on this virtual viewpoint path become the virtual viewpoint images that contain a precipitous virtual viewpoint path to the viewer. In the case where motions in y-axis direction, the pan direction, and the tilt direction are added to this motion in the x-axis direction, the generated virtual viewpoint images may possibly affect the viewer by an image sickness and the like.

### (Creation of Virtual Viewpoint Path)

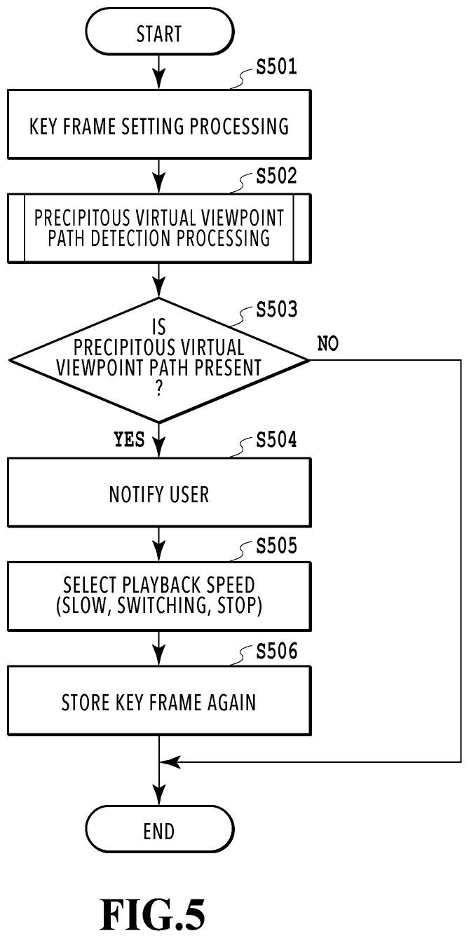

FIG. 5 is a flowchart for explaining processing procedures to create the virtual viewpoint path in the first embodiment of the present disclosure.

In S501, the virtual viewpoint operating unit 201 obtains the time code, the position and the orientation information on the virtual viewpoint, and the like to be designated as the key frame information based on a user operation, and registers these pieces of information with the key frame setting unit 202. The above-mentioned operation to register the key frame information is repeated at least twice, and the obtained information is stored in the key frame storing unit 203.

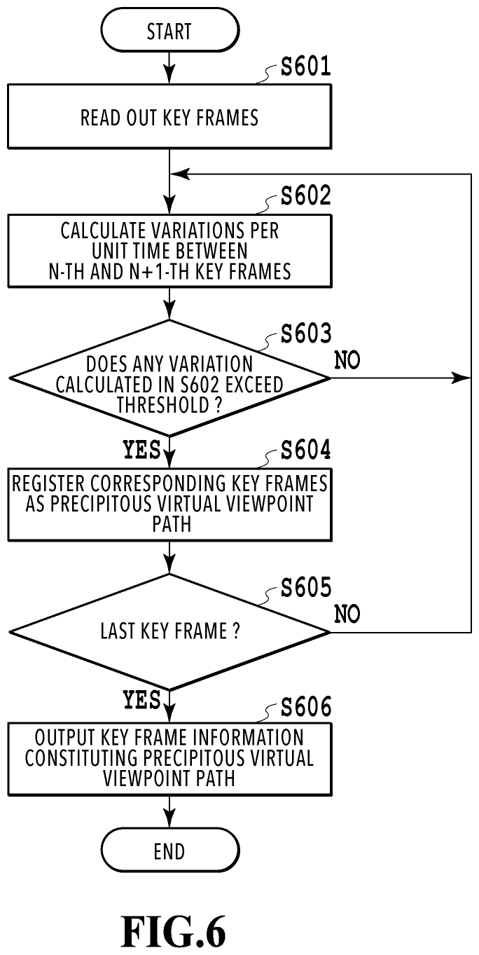

In S502, the virtual viewpoint variation measuring unit 204 detects a precipitous section in the virtual viewpoint path based on the key frame information stored in the key frame storing unit 203. More details will be described later with reference to a flowchart shown in FIG. 6.

In S503, the processing is terminated in the case where the virtual viewpoint variation measuring unit 204 does not detect any precipitous section in the virtual viewpoint path in S502. The processing proceeds to S504 in the case where the precipitous section is detected in the virtual viewpoint path.

In S504, the virtual viewpoint variation measuring unit 204 notifies the user of detection of the precipitous section in the virtual viewpoint path. Possible examples of the notification method include a text stating that “a precipitous virtual viewpoint path is created”, and display of a specific icon and the like determined in advance.

In S505, the image generating method determining unit 205 determines a method of generating a virtual viewpoint image between the respective key frames based on the variations of the virtual viewpoint parameters measured by the virtual viewpoint variation measuring unit 204 and on the virtual viewpoint parameters of the registered key frames.

Examples of the method of generating the virtual viewpoint image include a “slow” mode, a “switching” mode, a “stop” mode, and the like. The “slow” mode can suppress the variation per unit time in the virtual viewpoint image at the virtual viewpoint between the key fames, in which the precipitous virtual viewpoint path is detected, by setting a slow playback speed of the three-dimensional model between these frames. Here, in order to set the slow playback speed, the two virtual viewpoint parameters are associated with one time record of the captured image in a case of reducing the playback speed by half, for example. This “slow” mode is suitable for a case where a time interval between the key frames are extremely short or a case where a distance between the virtual viewpoints at two ends of the precipitous section is shorter than a predetermined distance. Application of the “slow” mode makes it possible to generate the virtual viewpoint image with the suppressed variation per unit time in the virtual viewpoint image while retaining a sense of speed of the virtual viewpoint image.

In the “switching” mode, the interpolation of the virtual viewpoint path between the key frames, in which the precipitous virtual viewpoint path is detected, is invalidated and one key frame is switched to another key frame without interpolating the virtual viewpoint path. For example, in a case where the positions of the virtual viewpoints are significantly distant from each other between the key frames, a virtual viewpoint image to be discontinuously switched from one key frame to another key frame is generated without creating the virtual viewpoint path between the key frames. This “switching” mode is considered to be useful in a case where a distance between the virtual viewpoints at two ends of the precipitous section is larger than a predetermined distance.

The “stop” mode is designed to move the virtual viewpoint during a set playback time period in a state of stopping time of the three-dimensional model between the key frames detected as the precipitous virtual viewpoint path, and to release the stop of the time of the three-dimensional model after moving the virtual viewpoint. In the case of setting the playback speed of the three-dimensional model to zero as mentioned above, the virtual viewpoint parameters corresponding to the playback time are associated with one time record of the captured image. This “stop” mode is considered to be useful in a case where the distance between the virtual viewpoints at the two ends of the precipitous section is larger than the predetermined distance, such as in a case of rising from a viewpoint near the ground to a bird's-eye viewpoint and a case of switching from a viewpoint on one side of a field to a viewpoint of another side thereof being the opposite side.

In the case of the “slow” mode or the “stop” mode where the virtual viewpoint parameters are interpolated between the virtual viewpoint parameters set as the key frames, the time code of each captured image to be associated is determined depending on the set playback speed. Here, the switching of these image generation methods may be set by the user or may be automatically determined on a system side based on a time interval between the key frames, a distance between the positions of the virtual viewpoints, and the like.

In S506, the playback speed adjusting unit 206 performs a change according to the above-described processing on the key frame information stored in the key frame storing unit 203, and stores the changed key frame information again.

### (Key Frame Information in Respective Image Generation Methods)

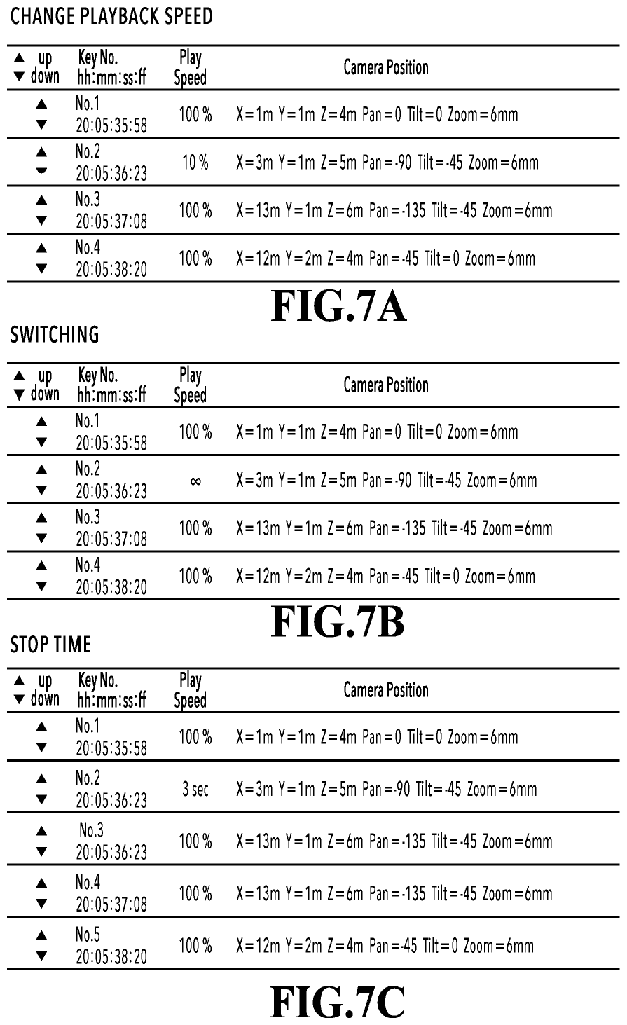

Here, a description will be given of results of change depending on the respective processing methods of the “slow” mode, the “switching” mode, and the “stop” mode on the key frame information in S506. FIGS. 7A to 7C show examples of the results of change of the key frame information.

FIG. 7A represents the example of the “slow” mode. FIG. 7A shows the key frame information subjected to playback speed adjustment. Based on variations per unit time of the virtual viewpoint parameters between the key frames, the section between the second and third key frames on the virtual viewpoint path being adjacent to each other on the time-series basis is detected as being precipitous, and the playback speed between the second and third key frames is set slow. In FIG. 7A, the playback speed between the second and third key frames is changed to be slower by setting the playback speed that is set in association with the second key frame one-tenth (10%) as fast as the normal playback speed (100%). A method of determining the playback speed in this case may be arranged such that the playback speed is set substantially equal to a moving speed of the virtual viewpoint between precedent and subsequent frames or that the playback speed is set to an arbitrary moving speed within a range not exceeding a threshold set in order to detect a precipitous virtual viewpoint path to be described later. Note that the method of determining the playback speed is not limited to these methods.

FIG. 7B represents the example of the “switching” mode. The playback speed of the section between the second and third key frames on the virtual viewpoint path, which are adjacent to each other on the time-series basis, is changed as with the case in FIG. 7A. Here, the playback speed after the change is set to co (infinity). This means that the playback speed between the second and third key frames is set to infinity, that is, to perform a switching operation to switch directly from the virtual viewpoint parameters of the second key frame to the virtual viewpoint parameters of the third key frame. In the switching operation, the virtual viewpoint parameters are once changed significantly and discontinuously, but are kept from being changed significantly and continuously. As a consequence, the obtained virtual viewpoint image is less likely to bring about an image sickness.

FIG. 7C represents the example of the “stop” mode. In FIG. 7C, only the virtual viewpoint is moved between the targeted key frames while stopping the time of the three-dimensional model. In the case where the section between the second and third key frames on the virtual viewpoint path, which are adjacent to each other on the time-series basis, is determined to be precipitous with respect to the initial key frame setting of FIG. 4, processing to add the following key frame between the second and third key frames is carried out.

The time code is the same as that of the second key frame (in the state of stopping the time of the three-dimensional model).

A new third key frame having the same position and the same orientation of the virtual viewpoint, that is, the same virtual viewpoint parameters as those of the original third key frame is generated and added. Since the same time code is associated with the second key frame and the new third key frame, the playback speed corresponding to the second key frame is set to zero and playback time for moving the virtual viewpoint is set as well. The setting of this playback time may be determined depending on a moving distance of the virtual viewpoint or may be arbitrary set by the user. By setting the playback time for moving only the virtual viewpoint while stopping the time of the three-dimensional model, it is possible to avoid generation of the virtual viewpoint image that includes the precipitous virtual viewpoint path.

### (Processing to Detect Precipitous Section in Virtual Viewpoint Path)

A detection flow of the precipitous section in the virtual viewpoint path, which is the processing by the virtual viewpoint variation measuring unit 204, will be described with reference to FIG. 6. In the present embodiment, the precipitous section is detected by the section corresponding to the interval between key frames in the virtual viewpoint path which are adjacent to each other on the time-series basis.

In S601, the virtual viewpoint variation measuring unit 204 reads out the key frames stored in the key frame storing unit 203.

In S602, the virtual viewpoint variation measuring unit 204 calculates the variations of the virtual viewpoint parameters per unit time in the captured images between the key frames, which are adjacent to each other on the time-series basis, out of the key frames read out in S601. The variations to be calculated are concerning the position information (x, y, z), the orientation information (pan, tilt, roll, angle-of-view information), and the like of the virtual viewpoint parameters. Here, it is not always necessary to calculate the variations per unit time in the captured images of the position information and the orientation information on the virtual viewpoints regarding all of the intervals between the key frames, and the variations between the key frames designated by the user may only be calculated instead.

In S603, a determination is made as to whether or not any of the variations of the virtual viewpoint parameters per unit time in the captured images between the targeted key frames calculated in S602 exceeds a threshold. Here, the threshold is assumed to be set by the user. In the meantime, a separate threshold may be set for each of the positional information and the orientation information on the virtual viewpoint parameters or a threshold may be set only for a particular parameter. The processing proceeds to S604 in the case where the variation exceeds the threshold. In the case where the variation is equal to or below the threshold, the processing proceeds to S602 to calculate the variations of the virtual viewpoint parameters per unit time in the captured images between the subsequent key frames.

In S604, the virtual viewpoint variation measuring unit 204 determines that the interval between the targeted key frames is the precipitous virtual viewpoint path, and registers this result of determination with the key frame information.

In S605, the virtual viewpoint variation measuring unit 204 proceeds to the processing in S602 unless the interval between the targeted frames is the last combination of the key frames read out in S601, or proceeds to processing in S606 in the case where the interval between the targeted frames is the last combination of the key frames read out in S601.

In S606, the virtual viewpoint variation measuring unit 204 outputs the key frame information determined as the precipitous virtual viewpoint path to the image generating method determining unit 205.

### (Adjustment of Criteria for Determination of Precipitous Virtual Viewpoint Path)

Here, criteria for determination of the precipitous virtual viewpoint path according to the present disclosure will be explained. In the case of rising from the viewpoint near the ground to the bird's-eye viewpoint or descending from the bird's-eye viewpoint to the viewpoint near the ground, the viewer of the virtual viewpoint image is less likely to feel an image sickness even in a case where there is a large amount of the variation per unit time in the virtual viewpoint image at the position of the virtual viewpoint. For this reason, the variation of the virtual viewpoint parameter per unit time in the captured images regarding the position in the z-axis direction (a vertical direction) may be excluded from the variations of the virtual viewpoint parameters per unit time in the captured images to be calculated in S602. Alternatively, the variation of the position in the z-axis direction (the vertical direction) may be calculated separately from the variations of the rest of the parameters, and the threshold for determination regarding the variation of the position in the z-axis direction (the vertical direction) may be set to a larger value as compared to the thresholds for the variations of the rest of the parameters.

Meanwhile, at a virtual viewpoint that is distant from an object such as the outdoor bird's-eye viewpoint, the change in the image corresponding to a variation per unit time of a virtual viewpoint parameter in the virtual viewpoint image becomes smaller as compared to the change at a virtual viewpoint that is close to the object such as the viewpoint near the ground. Accordingly, the magnitude of the threshold used to determine whether or not the virtual viewpoint path is precipitous may be changed depending such a distance between the virtual viewpoint and the object.

The processing to adjust these criteria for determination of the precipitous virtual viewpoint path may be carried out by the virtual viewpoint variation measuring unit 204.

### Second Embodiment

The first embodiment is the embodiment concerning the image generation by using the key frame method. On the other hand, the present embodiment shows an example of image generation by a manual operation of virtual viewpoints to be conducted by a user.

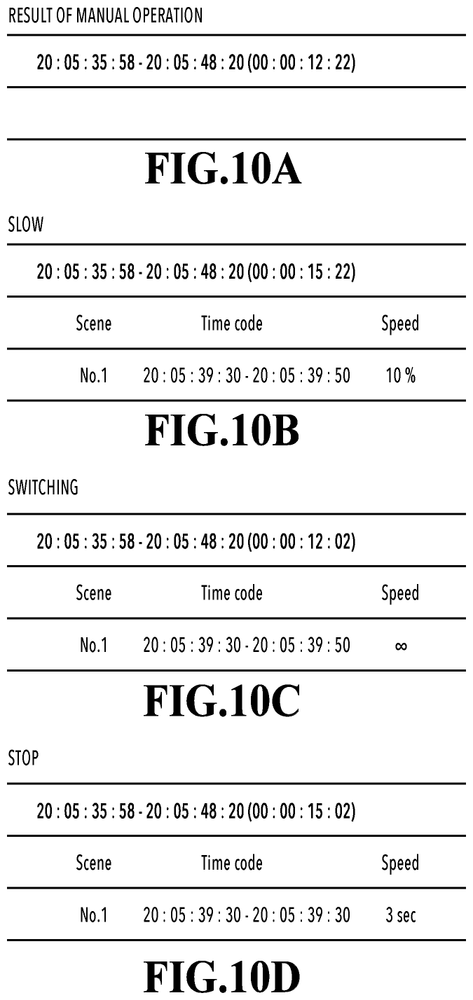

The present embodiment is based on a premise that a virtual viewpoint operating unit 801 is configured to include a start recording button, a stop recording button, and the like. Moreover, recording (image generation) is assumed to be started by pressing the start recording button and the like by the user so as to carry out a manual operation of virtual viewpoints, and the image generation is assumed to be terminated by pressing the stop recording button. FIG. 10A shows an example of time records representing a generated result of the image generation. FIG. 10A represents that an image is generated as a consequence of recording (frames corresponding to 00:00:12:22) from a start time code (a frame “20:05:35:58”) to an end time code (a frame “20:05:48:20”).

### (Outline of Configuration)

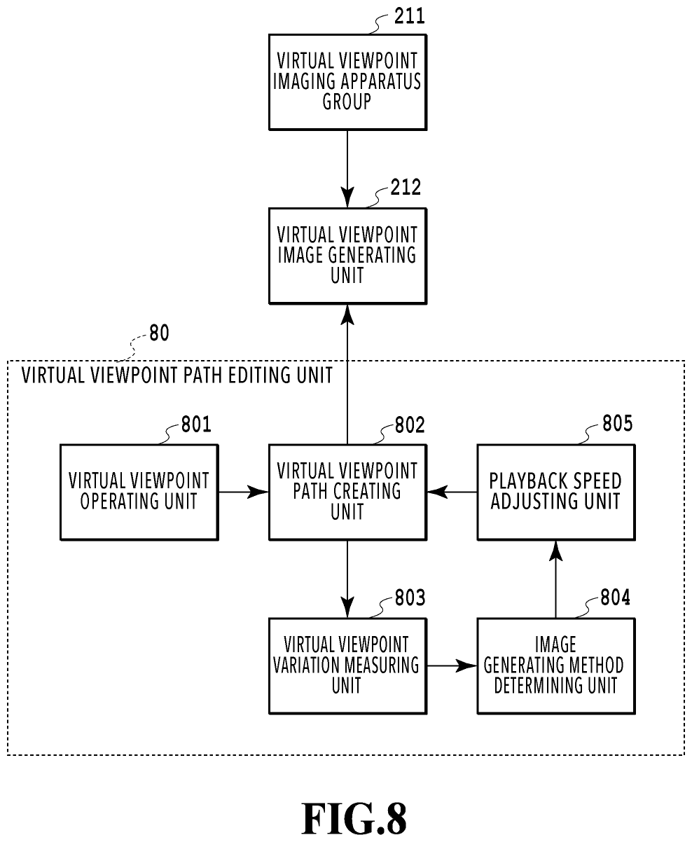

FIG. 8 is a schematic diagram of the present embodiment. Different features from those in the first embodiment will be mainly described below.

The virtual viewpoint operating unit 801 outputs a recording start instruction by the user to a virtual viewpoint path creating unit 802. The virtual viewpoint operating unit 801 also outputs virtual viewpoint parameters to the virtual viewpoint path creating unit 802, which are based on operation information on a virtual viewpoint in a case where the user performs the manual operation of the relevant virtual viewpoint.

The virtual viewpoint path creating unit 802 creates a virtual viewpoint path from the virtual viewpoint parameters based on the operation information on the virtual viewpoint outputted from the virtual viewpoint operating unit 801 and on playback speed information outputted from a playback speed adjusting unit 805, and outputs the created virtual viewpoint path to the virtual viewpoint image generating unit 212.

A virtual viewpoint variation measuring unit 803 measures the variations of the virtual viewpoints per unit time in the captured images from the virtual viewpoint path information generated by the virtual viewpoint path creating unit 802, and outputs the measured variations to an image generating method determining unit 804.

The image generating method determining unit 804 and the playback speed adjusting unit 805 have the same functions as the equivalent units in the first embodiment and explanations thereof will be omitted.

### (Creation of Virtual Viewpoint Path)

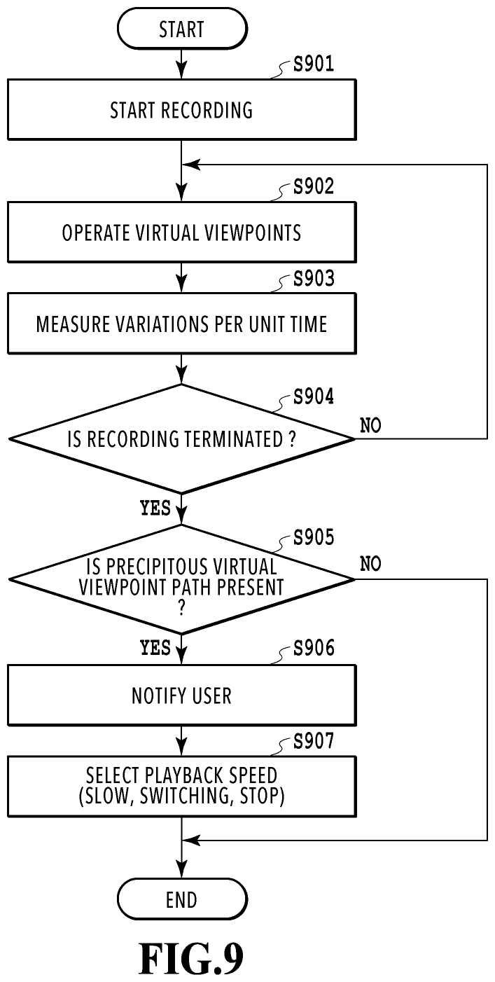

FIG. 9 is a flowchart for explaining processing procedures to create the virtual viewpoint path in the second embodiment of the present disclosure.

In S901, the virtual viewpoint path creating unit 802 starts recording the operation information on the virtual viewpoint in the case where the user input of the instruction to start the recording is outputted from the virtual viewpoint operating unit 801 to the virtual viewpoint path creating unit 802 as a consequence of the operation by the user to press the start recording button of the virtual viewpoint operating unit 801, and the like.

In S902, the virtual viewpoint path creating unit 802 records the virtual viewpoint parameters in the case where the user operates the virtual viewpoints with the virtual viewpoint operating unit 801 and virtual viewpoint parameters based on the operation information are outputted to the virtual viewpoint path creating unit 802. The virtual viewpoint parameters based on the operation information include the position information and the orientation information on the virtual viewpoint associated with the time code of each frame.

In S903, the virtual viewpoint variation measuring unit 803 measures the variations of the virtual viewpoint parameters per unit time in the captured image based on the virtual viewpoint path outputted from the virtual viewpoint path creating unit 802, and outputs the variations to the image generating method determining unit 804. Note that the unit time in this processing is assumed to be arbitrary time set in advance.

In S904, a determination is made as to whether or not an instruction to terminate the recording is outputted by an operation by the user such as pressing the stop recording button of the virtual viewpoint operating unit 801. In the case where the instruction to terminate the recording is not outputted, the processing returns to S902 and the procedures to record the virtual viewpoint parameters based on the operation information on the virtual viewpoint and to measure the variations of the virtual viewpoint parameters per unit time in the virtual viewpoint image are carried out. The processing proceeds to S905 in the case where the instruction to terminate the recording is outputted.

In S905, the image generating method determining unit 804 detects whether or not there is a precipitous motion of the virtual viewpoint based on the variations of the virtual viewpoint parameters per unit time in the virtual viewpoint image outputted from the virtual viewpoint variation measuring unit 803. Moreover, the image generating method determining unit 804 outputs, to the playback speed adjusting unit 805, information (the time code and the variations of the virtual viewpoint parameters at that point, and so forth) concerning the frame in which the precipitous virtual viewpoint path comes into being, which is the information representing a result of the detection. The detection method is the same as that in the first embodiment and explanations thereof will be omitted. In the case of the determination that there is the precipitous motion of the virtual viewpoint, the processing proceeds to S906. In the case where such a motion is not detected, the processing is terminated at this point.

In S906, the image generating method determining unit 804 notifies the user of the presence of the precipitous section in the virtual viewpoint path.

In S907, the image generating method determining unit 804 determines the image generation method based on the variations of the virtual viewpoint parameters measured by the virtual viewpoint variation measuring unit 803. Details are the same as those of the first embodiment and explanations will therefore be omitted. Meanwhile, the playback speed adjusting unit 805 determines the playback speed based on each section subjected to determination of the precipitous motion based on information concerning the virtual viewpoint in the precipitous section outputted from the image generating method determining unit 804, and outputs the determined playback speed to the virtual viewpoint path creating unit 802. Here, the information concerning the virtual viewpoint in the precipitous section includes the time code associated with the virtual viewpoint parameters in that section, the variations of the virtual viewpoint parameters in that section, and the like.

The image generating method determining unit 804 generates the virtual viewpoint image based on virtual viewpoint path information (the time codes of the respective virtual viewpoint parameters on the virtual viewpoint path and the playback speed of the three-dimensional model) outputted from the virtual viewpoint path creating unit 802.

### (Speed Adjustment)

Now, results of storing image clips in S907 will be described. FIGS. 10B to 10D represents examples of the stored results.

FIG. 10B represents the example of the “slow” mode. FIG. 10B shows that the playback speed of the section of the virtual viewpoint path designated by the time code No. 1 out of the generated images is set slow in the case where this section is determined to be precipitous. Although a method of determining the playback speed in this case is not limited to a particular method, the playback speed may be set substantially equal to moving speeds of the virtual viewpoints between precedent and subsequent thereto. Alternatively, the playback speed may be set to such a speed that is equal to or below a threshold for detecting a precipitous section on the virtual viewpoint path to be described later.

FIG. 10C represents the example of the “switching” mode. The playback speed of the section having the same time code as that in FIG. 10B is set to co (infinity). This means that the playback speed in this interval is set to infinity, that is, subjected to switching.

FIG. 10D represents the example of the “stop” mode. In FIG. 10D, the same time code is associated with the virtual viewpoint parameters in the precipitous section of the virtual viewpoint path. Processing to move only the virtual viewpoint while stopping the time of the three-dimensional model is carried out regarding the detected precipitous section of the virtual viewpoint path. Since the time of the three-dimensional model is stopped, the playback speed of the three-dimensional model is set to zero while setting playback time for moving the virtual viewpoint in the detected section. The setting of this playback time may be determined depending on the moving distance so as to avoid the precipitous virtual viewpoint path, or may be arbitrary set by the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to create a virtual viewpoint path for generating a virtual viewpoint image that is less likely to bring about an image sickness of an observer.

This application claims the benefit of Japanese Patent Application No. 2022-085916 filed May 26, 2022, which is hereby incorporated by reference wherein in its entirety.

What is claimed is:

1. An information processing apparatus that creates a virtual viewpoint path indicating a trajectory of positions of a virtual viewpoint in a virtual viewpoint image generated based on captured images obtained by image capturing from different directions by using a plurality of imaging apparatuses, comprising:
one or more memories storing instructions: and
one or more processors executing the instructions to:
accept parameters indicating virtual viewpoints corresponding to a plurality of key frames provided as references for the virtual viewpoint path; and
create the virtual viewpoint path by interpolating parameters indicating virtual viewpoints corresponding to an intermediate frame based on the parameters indicating the virtual viewpoints corresponding to the plurality of key frames accepted, wherein
in a case where a difference between the parameters indicated by two virtual viewpoints, which correspond to continuous two key frames out of the parameters indicating the virtual viewpoints corresponding to the plurality of key frames accepted, is larger than a threshold, the virtual viewpoint path is created such that the number of the virtual viewpoints corresponding to the intermediate frame to be interpolated between the parameters indicating the virtual viewpoints corresponding to the two key frames is larger than number of the virtual viewpoints in a case where the difference between the parameters indicated by the two virtual viewpoints is equal to or below the threshold.

2. The information processing apparatus according to claim 1, wherein
a playback speed of the captured images is set relative to a playback speed of the virtual viewpoint image between the continuous two key frames, and
the parameters indicating the virtual viewpoints are interpolated corresponding to the intermediate frames in number corresponding to the set playback speed.

3. The information processing apparatus according to claim 2, wherein
a user input is accepted to designate the playback speed between the two key frames, and
the playback speed between the two key frames is set based on the accepted playback speed.

4. The information processing apparatus according to claim 2, wherein
in a case where the difference between the parameters indicated by the two virtual viewpoints corresponding to the continuous two key frames is larger than the threshold, the playback speed between the two key frames is set slower.

5. The information processing apparatus according to claim 2, wherein
the playback speed between the two key frames is set, in which the difference between the parameters indicated by the corresponding two virtual viewpoints is larger than the threshold, to be substantially equal to the playback speed between the key frames adjacent to the two key frames.

6. An information processing apparatus that creates a virtual viewpoint path indicating a trajectory of positions of a virtual viewpoint in a virtual viewpoint image generated based on captured images obtained by image capturing from different directions by using a plurality of imaging apparatuses, comprising:
one or more memories storing instructions: and
one or more processors executing the instructions to:
accept parameters indicating virtual viewpoints corresponding to a plurality of key frames provided as references for the virtual viewpoint path; and
create the virtual viewpoint path by interpolating parameters indicating virtual viewpoints corresponding to an intermediate frame based on the parameters indicating the virtual viewpoints corresponding to the plurality of key frames accepted, wherein
in a case where a difference between the parameters indicated by two virtual viewpoints, which correspond to continuous two key frames out of the parameters indicating the virtual viewpoints corresponding to the plurality of key frames accepted, is larger than a threshold, the virtual viewpoint path is created without interpolating between the parameters indicating the virtual viewpoints corresponding to the two key frames with the parameters indicating the virtual viewpoints corresponding to the intermediate frame.

7. The information processing apparatus according to claim 6, wherein
a playback speed of the captured images is set relative to a playback speed of the virtual viewpoint image between the two key frames, and
the parameters indicating the virtual viewpoints are interpolated corresponding to the intermediate frames in number corresponding to the set playback speed, and
in a case where the difference between the parameters indicated by the two virtual viewpoints corresponding to the continuous two key frames is larger than the threshold, the playback speed between the two key frames is set to infinity.

8. An information processing apparatus that creates a virtual viewpoint path indicating a trajectory of positions of a virtual viewpoint in a virtual viewpoint image generated based on captured images obtained by image capturing from different directions by using a plurality of imaging apparatuses, comprising:
one or more memories storing instructions: and
one or more processors executing the instructions to:
accept parameters indicating virtual viewpoints corresponding to a plurality of key frames provided as references for the virtual viewpoint path; and
create the virtual viewpoint path by interpolating parameters indicating virtual viewpoints corresponding to an intermediate frame based on the parameters indicating the virtual viewpoints corresponding to the plurality of key frames accepted, wherein
in a case where a difference between the parameters indicated by two virtual viewpoints, which correspond to continuous two key frames out of the parameters indicating the virtual viewpoints corresponding to the plurality of key frames accepted, is larger than a threshold, the virtual viewpoint path is created by allocating equal time corresponding to the captured images to the parameters indicating the virtual viewpoints corresponding to the intermediate frame to be interpolated between the parameters indicating the virtual viewpoints corresponding to the two key frames.

9. The information processing apparatus according to claim 8, wherein
a playback speed of the captured images is set relative to a playback speed of the virtual viewpoint image between the two key frames, and
the parameters indicating the virtual viewpoints are interpolated corresponding to the intermediate frames in number corresponding to the set playback speed between the parameters indicating the virtual viewpoints corresponding to the continuous two key frames,
in a case where the difference between the parameters indicated by the two virtual viewpoints corresponding to the continuous two key frames is larger than the threshold, the playback speed between the two key frames is set to zero and sets playback time, and
the parameters indicated by the two virtual viewpoints are interpolated corresponding to the intermediate frames in number corresponding to the set playback time, and allocates the equal time corresponding to the captured images to the interpolated parameters.

10. The information processing apparatus according to claim 1, wherein
the parameters include parameters indicating positions and orientations of the virtual viewpoints.

11. The information processing apparatus according to claim 1, wherein
the difference between the parameters excludes a difference in position in a vertical direction between the two virtual viewpoints.

12. The information processing apparatus according to claim 1, further comprising:
the virtual viewpoint image is generated based on the captured images and the created virtual viewpoint path.

13. An information processing method for creating a virtual viewpoint path indicating a trajectory of positions of a virtual viewpoint in a virtual viewpoint image generated based on captured images obtained by image capturing from different directions by using a plurality of imaging apparatuses, comprising:
accepting parameters indicating virtual viewpoints corresponding to a plurality of key frames provided as references for the virtual viewpoint path; and
creating the virtual viewpoint path by interpolating parameters indicating virtual viewpoints corresponding to an intermediate frame based on the parameters indicating the virtual viewpoints corresponding to the plurality of key frames accepted, wherein
in a case where a difference between the parameters indicated by two virtual viewpoints, which correspond to continuous two key frames out of the parameters indicating the virtual viewpoints corresponding to the plurality of key frames accepted, is larger than a threshold, the virtual viewpoint path is created such that the number of the virtual viewpoints corresponding to the intermediate frames to be interpolated between the parameters indicating the virtual viewpoints corresponding to the two key frames is larger than number of the intermediate frames in a case where the difference between the parameters indicated by the two virtual viewpoints is equal to or below the threshold.

14. An information processing method for creating a virtual viewpoint path indicating a trajectory of positions of a virtual viewpoint in a virtual viewpoint image generated based on captured images obtained by image capturing from different directions by using a plurality of imaging apparatuses, comprising:
accepting parameters indicating virtual viewpoints corresponding to a plurality of key frames provided as references for the virtual viewpoint path; and
creating the virtual viewpoint path by interpolating parameters indicating virtual viewpoints corresponding to an intermediate frame based on the parameters indicating the virtual viewpoints corresponding to the plurality of key frames accepted, wherein
in a case where a difference between the parameters indicated by two virtual viewpoints, which correspond to continuous two key frames out of the parameters indicating the virtual viewpoints corresponding to the plurality of key frames accepted, is larger than a threshold, the virtual viewpoint path is created without interpolating between the parameters indicating the virtual viewpoints corresponding to the two key frames with the parameters indicating the virtual viewpoints corresponding to the intermediate frame.

15. An information processing method for creating a virtual viewpoint path indicating a trajectory of positions of a virtual viewpoint in a virtual viewpoint image generated based on captured images obtained by image capturing from different directions by using a plurality of imaging apparatuses, comprising:
accepting parameters indicating virtual viewpoints corresponding to a plurality of key frames provided as references for the virtual viewpoint path; and
creating the virtual viewpoint path by interpolating parameters indicating virtual viewpoints corresponding to an intermediate frame based on the parameters indicating the virtual viewpoints corresponding to the plurality of key frames accepted, wherein
in a case where a difference between the parameters indicated by two virtual viewpoints, which correspond to continuous two key frames out of the parameters indicating the virtual viewpoints corresponding to the plurality of key frames accepted, is larger than a threshold, the virtual viewpoint path is created by allocating equal time corresponding to the captured images to the parameters indicating the virtual viewpoints corresponding to the intermediate frame to be interpolated between the parameters indicating the virtual viewpoints corresponding to the two key frames.

16. A non-transitory computer readable storage medium storing a program for an information processing method for creating a virtual viewpoint path indicating a trajectory of positions of a virtual viewpoint in a virtual viewpoint image generated based on captured images obtained by image capturing from different directions by using a plurality of imaging apparatuses, the program causing a computer to execute:
accepting parameters indicating virtual viewpoints corresponding to a plurality of key frames provided as references for the virtual viewpoint path; and
creating the virtual viewpoint path by interpolating parameters indicating virtual viewpoints corresponding to an intermediate frame based on the parameters indicating the virtual viewpoints corresponding to the plurality of key frames accepted, wherein
in a case where a difference between the parameters indicated by two virtual viewpoints, which correspond to continuous two key frames out of the parameters indicating the virtual viewpoints corresponding to the plurality of key frames accepted, is larger than a threshold, the virtual viewpoint path is created by allocating equal time corresponding to the captured images to the parameters indicating the virtual viewpoints corresponding to the intermediate frame to be interpolated between the parameters indicating the virtual viewpoints corresponding to the two key frames.
